(19) United States
(12) Patent Application Publication
(10) Pub. No.: US 2014/0098727 A1
(43) Pub. Date: Apr. 10, 2014

(54) METHODS AND APPARATUS FOR NETWORK SIGNALING DURING LOW-POWER OPERATION

(71) Applicant: Apple Inc., Cupertino, CA (US)

(72) Inventors: Anthony D. Murabito, Cupertino, CA (US); Dmitry Halavin, Cupertino, CA (US); Naresh Kumar Chinnathambi Kailasam, Cupertino, CA (US)

(73) Assignee: Apple Inc., Cupertino, CA (US)

(21) Appl. No.: 13/941,218

(22) Filed: Jul. 12, 2013

Related U.S. Application Data
(60) Provisional application No. 61/709,898, filed on Oct. 4, 2012.

(51) Int. Cl. H04W 52/02

(52) U.S. Cl. CPC H04W 52/0235
USPC 370/311

(57) ABSTRACT

Methods and apparatus for signaling during a low power state. Wireless devices that are operating in “sleep” modes may be kicked off wireless local area network (WLAN) networks due to inactivity. Consequently, in one regard, a client device is disclosed that programs its firmware to periodically transmit “keep-alive” messages. In one exemplary variant, the keep-alive message is a unicast address resolution protocol (ARP) message that is addressed to the network gateway. This keep-alive ARP prevents the device from being kicked off the network, which reduces wake up times, yet still permits low power operation, thereby conserving device power and enhancing user experience.

### PRIORITY AND RELATED APPLICATIONS

The present application claims priority to co-owned, co-pending U.S. Provisional Patent Application Ser. No. 61/709,898, filed Oct. 4, 2012, entitled “METHODS AND APPARATUS FOR NETWORK SIGNALING DURING LOW-POWER OPERATION”, the foregoing being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technical Field

The present disclosure relates generally to the field of mobile technology and wireless communications. More particularly, one exemplary embodiment is directed to wireless devices which are configured to transmit signaling (e.g., a “keep-alive” signal) during low-power operation.

2. Description of Related Technology

Wi-Fi™ is a trademarked term for devices which comply with the Institute of Electrical and Electronic Engineers (IEEE) 802.11 family of standards. Due to the popularity of the IEEE 802.11 standard, Wi-Fi is synonymous with the more generic term Wireless Local Area Network (WLAN); however, it is appreciated that other WLAN technologies exist.

Generally, WLAN technologies enable WLAN devices to transact data within a computer network and/or ad hoc peer-to-peer connections. WLANs typically include one or more access points (APs) that manage a wireless network of client devices or stations (STAs). During operation, an STA must synchronize, associate, and optionally authenticate with a network before the AP and STA can transact data.

Traditionally, Wi-Fi STA devices were computers having a relatively short transmission range (100 m) thus power considerations were not a significant design concern. Early Wi-Fi STAs were constantly active. The existing IEEE 802.11 standards do not mandate how APs should handle inactive STAs; however, typical AP implementations are configured to eject or “kick” inactive STAs off of the network (e.g., where inactivity is measured with a timer, etc.).

However, as devices have evolved to smaller and more aggressive form factors (such as for example the exemplary iPhone™ and MacBook Air™, manufactured by the Assignee hereof), power consumption has become increasingly important. To these ends, the next generation of consumer electronics has increasingly adopted more comprehensive and aggressive power reduction techniques, including for example, low-power operational modes. For instance, some existing Wi-Fi devices may not transition into so-called “sleep” or “hibernation” states. In low-power states, one or more components of a device are dropped into lower performance states (e.g., lower voltages, lower clock rates, etc.), or powered down completely. Anecdotal evidence has shown that during certain low-power modes (e.g., sleep modes, hibernation modes, etc.) existing STAs may be kicked off of a WLAN for being inactive. Unfortunately, when a STA is kicked from the WLAN, the STA must reconnect to the network again, which may consume more power and adversely affect the perceived STA's network connectivity. Stated differently, if a particular mobile device does not implement certain sleep or hibernation modes, it will consume power even though it is not actively transferring data. However, if the mobile device transitions to a sleep/hibernation mode, it may be kicked off the WLAN, and forced to implement re-establishment procedures (which may negate the benefits of the sleep/hibernation mode).

Accordingly, new solutions are needed that enable an STA to remain on a wireless network during low-power operation. More generally, improved methods and apparatus are needed to address low-power operation in a manner which reduces network ejection.

### SUMMARY

The present disclosure provides, inter alia, improved apparatus and methods for performing signaling (such as e.g., so-called “keep-alive” signaling) within wireless networks during low-power operation.

A method of operation of a wireless-enabled device is disclosed. In one embodiment, the message includes, during a normal state, configuring one or more messaging parameters, where at least one of the messaging parameters comprises a network-based address; and responsive to a sleep event, transitioning to a low power state. In one variant, during the low power state, the method further includes: transmitting one or more messages to the network-based address, the one or more messages causing transmission of corresponding one or more responses; storing the one or more responses; and responsive to a wake event, resuming the normal state.

A method for transmitting a keep-alive message during a low power state, is also disclosed. In one embodiment, the method includes: during a normal state: configuring one or more keep-alive messaging parameters; and responsive to a sleep event, transitioning to a low power state. In one variant, at least one of the keep-alive messaging parameters includes a network gateway address. In another embodiment, the method includes: during the low power state: transmitting one or more keep-alive messages (e.g., to the network gateway address), the one or more keep-alive messages causing transmission of corresponding one or more responses; storing the one or more responses; and responsive to a wake event, resuming the normal state.

An apparatus configured to transmit messaging during a low power state, is also disclosed herein. In one embodiment, the apparatus includes: a processor, a non-transitory computer-readable medium, a wireless transceiver, and a power management subsystem. In one exemplary variant, the non-transitory computer-readable medium further includes instructions which when executed by the processor, cause the apparatus to: configure one or more message (e,g., keep-alive messaging) parameters, where at least one of the messaging parameters comprises a network gateway address; and responsive to a sleep event, transition to a low power state. In another exemplary variant, the non-transitory computer-readable medium includes instructions which when executed by the processor, cause the apparatus to: during the low power state: transmit one or more keep-alive messages to the network gateway address, the one or more keep-alive messages causing transmission of corresponding one or more responses; store the one or more responses; and responsive to a wake event, resume the normal state.

In another embodiment, the apparatus includes: logic configured to transmit a keep-alive message during a low power state; where the keep-alive message is an address resolution protocol (ARP) message addressed to a network entity.

A method is further disclosed herein. In one embodiment, the method includes: configuring a firmware process to transmit a keep-alive message during a low power state;

transitioning to a low power state; transmitting messaging; and once a wake event has occurred, waking up.

A network entity is also disclosed herein. In one embodiment, the network entity is configured to prevent a client device from being excluded from a network, based on keep-alive messaging. In one variant, the network entity provides one or more parameters useful for keep-alive messaging. In other variants, the keep-alive messages are addressed to the network entity.

A system for preventing exclusion from a network based on inactivity during a low power state is disclosed. In one variant, at least one entity of the system provides one or more parameters useful for keep-alive messaging. In other variants, the system routes one or more keep-alive messages to the network entity.

A method for operating a user equipment (UE) device of a wireless network is disclosed. In one embodiment, the method includes: configuring one or more messaging parameters, where at least one of the messaging parameters comprises an address of the network; responsive to a sleep event, transitioning to a low power state; and during the low power state: transmitting at least one message comprising the at least one messaging parameter, the at least one message causing a transmission of a corresponding one or more responses by a network entity; storing the one or more responses; and responsive to a wake event, resuming a normal state.

In one variant, the network entity comprises a gateway of the network, the address corresponds to the gateway of the network, and the at least one message comprises a unicast address resolution protocol (ARP) message. In other variants, the at least one message comprises a broadcast address resolution protocol (ARP) message, and the address corresponds to another UE device within the network. In still another alternate, the at least one message comprises a domain name system query, and the address corresponds to a domain name server within the network.

In one implementation, the at least one message comprises a keep-alive message, and the address corresponds to the user equipment device transmitting the at least one message.

In other variants, the method includes detecting one or more of a lack of activity, or a lack of user input. In some cases, when one or more of the lack of activity or the lack of user input is detected, the sleep event is triggered. In other variants, the user input comprises one or more of a button press, an audible input, a device motion, or a touch screen input.

In some variants, the wake event is triggered based on one or more of user input, application activity, or network activity.

In other variants, the wake event is based on a timer.

Still further, other implementations may be characterized by a lower power consumption in low power mode compared to a normal mode consumption.

A portable radio communications apparatus is disclosed. In one embodiment, the apparatus includes: a processor; a power source configured to power the processor during a not mode of operation and not power at least a portion of the processor during a low power mode of operation; a wireless interface; and when the processor is unpowered, logic configured to: transmit one or more keep-alive messages to at least one wireless local area network (WLAN) entity; where the one or more keep-alive messages are configured to cause the at least one WLAN entity to respond; and receive one or more responses to the keep-alive message.

In some variants, the at least one WLAN entity comprises a gateway of the network, and the one or more keep-alive messages comprise a unicast address resolution protocol (ARP) message. Alternatively, the one or more keep-alive messages comprise a broadcast address resolution protocol (ARP) message, and the at least one WLAN entity is another UE device. Still other variants, may use keep-alive messages that comprise a domain name system query, and the at least one WLAN entity corresponds to a domain name server.

In some implementations, the logic is configured to store the received one or more responses in non-transitory computer readable medium. Certain such implementations may additionally be configured to retrieve the stored one or more responses upon a wakeup condition.

An access point apparatus is disclosed. In one embodiment, the access point apparatus includes: a processor; a wireless transceiver; and logic configured to enable a client device to operate in a low power mode without unnecessarily kicking the client device from the wireless network. In one embodiment, the logic is configured to, during a low power state of a client device: responsive to reception of one or more messages from the client device, maintain a session of the client device within the network.

In one variant, the one or more messages comprise one or more messages comprise a unicast address resolution protocol (ARP) message. Alternatively, the one or more messages comprise a broadcast address resolution protocol (ARP) message.

Other features and advantages principles described hereinafter will immediately be recognized by persons of ordinary skill in the art with reference to the attached drawings and detailed description of exemplary embodiments as given below.

### BRIEF DESCRIPTION OF THE DRAWINGS

FIG. 1 is a logical block diagram of one exemplary client apparatus in accordance with various principles disclosed herein.

FIG. 2 is a logical flow diagram of one embodiment of a method for transmitting keep-alive messaging to a wireless network during low-power operation.

FIG. 3 is a logical block diagram of one exemplary embodiment of a client apparatus in accordance with various principles disclosed herein.

FIG. 4 is a logical flow diagram of an exemplary embodiment of a keep-alive messaging scheme for a Wi-Fi STA client device.

FIG. 5 is a functional block diagram illustrating one embodiment of a radio frequency serving device configured in accordance with the invention.

All Figures © Copyright 2012-2013 Apple Inc. All rights reserved.

### DETAILED DESCRIPTION

Reference is now made to the drawings, wherein like numerals refer to like parts throughout.

### Overview

In one embodiment, a client device is disclosed that is configured to maintain minimum signaling activity (such as for example, keep-alive messages) during a low power state. In one exemplary implementation, the keep-alive message is a unicast address resolution protocol (ARP) message that is addressed to a network gateway. ARP messages generally cannot be ignored; i.e., existing network IP protocols ensure that ARP messages are always delivered. As described in greater detail herein, the exemplary client device includes firmware that remains operational during “sleep” modes.

Various other embodiments and variants are described in greater detail herein. In one such implementation, the client device is configured to transmit keep-alive messages according to a periodic interval. Still other variants ma additionally queue the responses to keep-alive messaging, thereby further streamlining a “wake-up” process. Still further, certain implementations may optimize behavior according to various considerations (e.g., user experience, device requirements, application considerations, etc.)

Other implementation considerations are discussed including e.g., other forms of keep-alive messaging, time interval considerations, etc.

### DETAILED DESCRIPTION OF EXEMPLARY EMBODIMENTS

Exemplary embodiments are now described in detail. While these embodiments are primarily discussed in the context of wireless local area networks (WEAN), the present disclosure is in no way so limited. Various principles described herein may for example be configured for other types of networks including, without limitation, cellular networks, wireless metropolitan area networks (WMAN), wireless personal area networks (WPAN), peer-to-peer networks, ad hoc wireless networks, etc., (as well as non-IEEE Std. 802.11 based WLANs)

Exemplary Client Apparatus

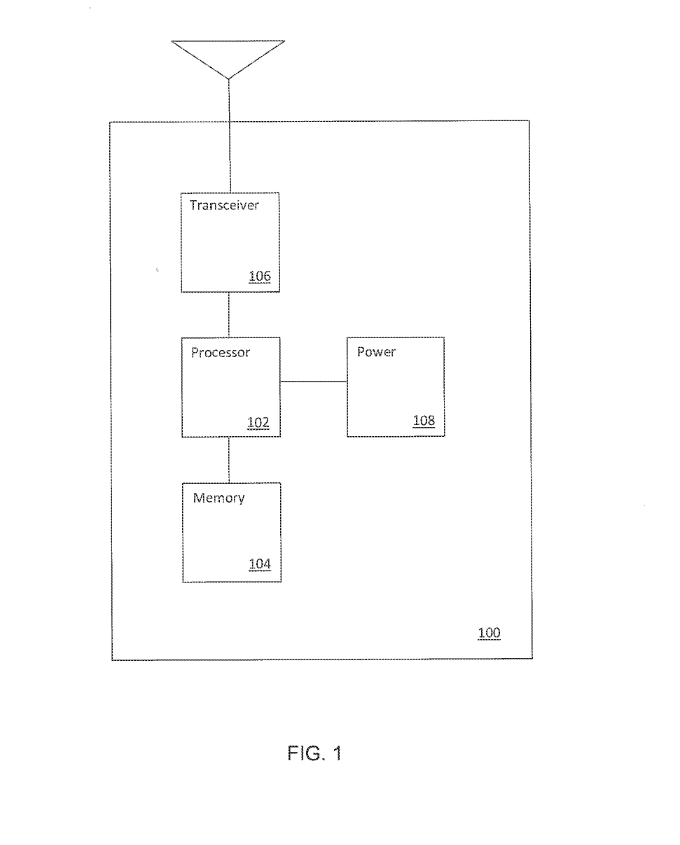

FIG. 1 illustrates one exemplary embodiment of a client apparatus 100 configured to periodically transmit “keep-alive” messaging to a wireless network during low-power operation. As used herein, the terms “client apparatus”, “client device”, etc. include, but are not limited to, cellular telephones, smart phones (such as for example an iPhone™), personal computers (PCs), such as for example Macbook™, Macbook Pro™ Macbook Air™, and minicomputers, whether desktop, laptop, or otherwise, as well as mobile devices such as handheld computers, PDAs, video cameras, set-top boxes, personal media devices (PMDs), such as for example an iPod™, tablet computers such as the exemplary iPad™, so-called “phablets”, display devices, or any combinations of the foregoing. While a specific device configuration and layout is shown and discussed, it is recognized that many other implementations may be readily implemented by one of ordinary skill given the present disclosure, the client apparatus 100 of FIG. 1 being merely illustrative of the broader principles of the invention.

As shown, the client apparatus 100 includes a processor 102, a non-transitory computer-readable medium 104, a wireless transceiver 106, and a power management subsystem 108.

In one exemplary embodiment, the processor 102 includes one or more of central processing units (CPU) or digital processors, such as a microprocessor, digital signal processor, field-programmable gate array (FPGA), plurality of processing components mounted on one or more substrates, etc. Moreover, while the illustrated embodiment has a single processor, it is readily appreciated by those of ordinary skill in the related arts that alternative implementations may include multiple processors, including for instance network processor(s), application processor(s), secure microprocessors, etc.

The processor 102 is coupled to the non-transitory computer-readable medium which may include for example SRAM, FLASH, SDRAM, and/or HDD (Hard Disk Drive) components. As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

Existing memory technologies are further subdivided into volatile and non-volatile memory. Volatile memory only retains data as long as it is powered. Non-volatile memory does not require power to store data. Generally, volatile memory is faster and more economical than non-volatile memory thus high level software is generally loaded into, and executed from volatile memory. High level software generally includes e.g., an operating system (OS), device drivers, communication stacks, and 3^{rd} party applications, etc. Non-volatile memory is used for storing software programs, and also for firmware execution; firmware is low-level software that is typically limited to direct manipulation of hardware components.

In one embodiment, the wireless transceiver 106 is configured to receive one or more wireless data transmissions. In one exemplary implementation, the wireless transceiver 106 includes a Wi-Fi™ modem and radio. In some variants, the radio may include: one or more antennas (the latter to support, e.g., MIMO functionality), analog to digital converters (ADC), digital to analog converters (DAC), mixers, filters, duplexers, diplexers, switches, and/or other components. The transceiver 106 may support one or more other wireless technologies e.g., cellular technologies (e.g., Global System for Mobile Communications (GSM), General Radio Packet Service (GPRS), Enhanced Data Rates for GSM Evolution (EDGE), Long Term Evolution (LTE), LTE-Advanced (LTE-A), Interim Standard 95 (IS-95), Interim Standard 2000 (IS-2000, also referred to as CDMA2000), CDMA 1XEV-DO, Time Division Single Carrier CDMA (TD-SCDMA), Long Term Evolution (LTE), Time Division LTE (TD LTE), etc.), personal area network technologies (e.g., Bluetooth, Zigbee, wireless USB, etc.). The client apparatus 100 may be configured with multiple wireless or air interfaces, such as for example cellular/WLAN/PAN, cellular/WMAN/PAN/WLAN, and/or other wireless networks.

In one embodiment, the power management subsystem 108 is configured to provide power to the client apparatus, and may include an integrated circuit and or a plurality of discrete electrical components. In one exemplary apparatus, the power management subsystem 108 interfaces with a battery. In some implementations, the interface may comprise the DC output of an AC voltage transformation and rectification circuit (not shown).

The client apparatus 100 is further configured to transition among one or more low power modes. In a normal operation, the client apparatus is configured to execute one or more high level software applications; however, during “sleep” operation, only the firmware is running (e.g., other higher level software has been suspended). Moreover, those of ordinary skill in the related arts will readily appreciate that the foregoing scheme is purely illustrative; other implementations may incorporate multiple additional gradations of low power operation. Common examples include for example: lowered component operating voltage or current draw modes, reduced clock speeds, hibernation modes (where volatile memories remain powered), deep sleep modes (where firmware is only briefly woken periodically), shutting off processor cores (or portion thereof) and/or memory (or other components). For example, the client device may be configured to power down a portion of its radio transceiver during low power modes. These low power modes may be based on a predetermined schedule, or according triggered based on a dynamic optimizations (e.g., lack of use, etc.). In some implementations, a client device supporting multiple transceivers may independently power down one or more of the transceivers according to usage considerations, etc.

Referring once again to sleep mode operation, in one embodiment, the firmware is programmed to periodically transmit keep-alive messages. In one such variant, the keep-alive messages are of limited complexity and advantageously do not require other data traffic. Moreover, the firmware is further configured to store responses (sent in response to the keep-alive messages) within memory for later use in updating the high level software when the client apparatus wakes (i.e., has sufficient functionality “alive” to process the messages).

### Methods

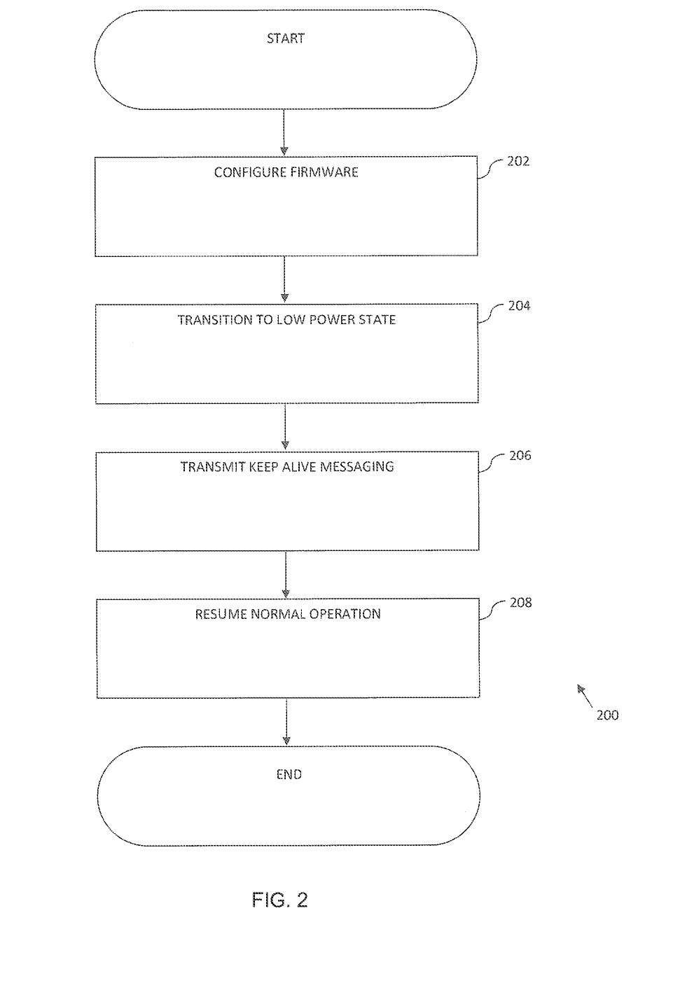

Referring now to FIG. 2, a logical flow diagram of a method 200 for transmitting keep-alive messaging to a wireless network during low-power operation is disclosed.

At step 202 of the method 200, a client device configures its firmware to transmit a keep-alive message during a low power state. In one exemplary variant, the keep-alive message is a unicast address resolution protocol (ARP) message of a gateway entity (i.e., which is transmitted to the gateway entity) of the wireless network. The ARP message protocol is commonly used for resolution of network layer addresses (such as an internet protocol (IP) address) to link layer addresses (such as a hardware medium access control (MAC) address). While other message types may be used for keep-alive messages (and other types of message in general may be used), the exemplary ARP message advantageously has certain features which are desirable within a broad range of usages (described hereinafter).

In one embodiment, the keep-alive messages are configured for transmission according to a periodic interval. For example, based on empirical evidence, it has been determined by the Assignee hereof that a client device that transmits a keep-alive message once every 90 seconds will be considered “active” within the vast majority of Wi-Fi networks. It will be appreciated that this value may be varied consistent with the present disclosure, and moreover that it may be varied based on situation (e.g., a first value used in a first situation or type of network, and a second (different) value in a second situation/network).

For instance, in some variants, the periodic basis is a static value. In other embodiments, the periodic basis is determined on a semi-static basis. In one such scenario, the periodic basis is determined based on historic performance on a network. For example, the client device may use increasingly longer intervals, and determine an appropriate time interval by process of trial and error. In other embodiments, the client device may be instructed (e.g., by a remote database, a network entity, the AP itself, etc.) as to what an appropriate keep-alive interval should be.

In still other variants, the periodic basis is determined based on one or more considerations. Common examples of such considerations include for example, user configurable settings, power consumption requirements, network settings, application requirements, and manufacturer requirements. For example, a user may be willing to adjust performance according to various manufacturer-configured modes that trade performance for lower power consumption requirements, etc.

In one embodiment, the keep-alive messages are unicast. By addressing the keep-alive message to fewer entities, the keep-alive messaging will not significantly impact existing network traffic. However, it is appreciated that the address must be valid. For this reason, in one exemplary variant, the keep-alive message is addressed to the gateway entity, such as via use of its IP address. The gateway entity will always be present (and will always be unique) where the client device has access to the Internet. Moreover, the gateway responses can be stored economically. Alternately, the keep-alive messages may be broadcast or multicast in some implementations. In one variant, a MAC address of a device may be used if known.

In one exemplary variant, the keep-alive messages are address resolution protocol (ARP) messages. In some variants, the keep-alive messages may be a null packet that includes null data. In still other variants, the keep-alive messages are a domain name system (DNS) query. Those of ordinary skill in the related arts will appreciate, given the contents of the present disclosure, that still other types of messages can be substituted.

As a brief aside, an ARP message is a simple request which is routed via network protocols (not link layer protocols), and requires a response (i.e., cannot be ignored). Ordinary artisans will appreciate that certain types of network transactions can be filtered or ignored by network entities to optimize overall network operation; for example, a device that transmits a packet to its own address (effectively transmitting to itself), may be ignored. Similarly, data packets which are empty may not be transmitted, etc. In contrast, existing network IP protocols ensure that ARP messages are always delivered.

As previously noted, in one implementation, keep-alive ARP messages are directed to a gateway. In other examples, the keep-alive ARP messages may be addressed to the AP or a client device. In fact, in some embodiments (e.g., where the network does not prevent such behavior), the client apparatus may ARP itself.

Referring back to FIG. 2, at step 204 of the method 200, the client device transitions to a low power state. In one embodiment, the client device suspends any high level software applications, and allows the firmware to continue minimal processing. Common examples of minimal processing include for example monitoring for one or more wake events, updating timers, interrupt handling, etc.

In other alternative embodiments, the client device may still allow relatively high functioning software applications which do not require network connectivity. Common examples of such applications include e.g., multimedia file playback (e.g., text, audio and/or video data, etc.), standalone operation (e.g., as in non-networked games, and/or utilities, etc.).

In one embodiment, the low power state is triggered by the user. For example, in one embodiment, the user can trigger low power operation with a button press, switch, closing a clamshell form factor, hand gesture, speech recognition command (e.g., “go to sleep”), etc. In still other variants, the input may be within a software user interface e.g., mouse selection, touch screen input, etc.

In other embodiments, the low power state is triggered by one or more applications. Common examples of such applications include without limitation: inactivity timers, process termination (e.g., closing an application), predetermined low power operation (e.g., according to a schedule), etc. For example, a device which has not been used for a predetermined time interval may automatically transition to a low power mode. In other examples, a device may be configured to automatically transition to a low power state once it has completed a task or an event has occurred (e.g., completion of an operation such as a file download, receipt of an acknowledgement message, etc.)

In one variant, the low power state is triggered by a lack of activity. For example, in one such implementation, a user which has not used the client device within a specified time interval may trigger subsequent low power operation (e.g., the screen being powered down, network connectivity being powered down, the processor going to sleep, and storing volatile memory contents to non-volatile memory, etc.). The lack of activity may be determined by any number of different criteria, such as e.g., lack of input via a touch screen or mouse or speech user interface, lack of motion of the device (e.g., via indigenous accelerometer or the like), etc.

In some embodiments, low power operation may be “tiered” into stages that are responsively triggered for longer and longer periods of non-use; e.g., after a first interval the screen is powered down, after a second interval the network connectivity is powered down, etc.). Various other forms of low power mode operation will be readily appreciated by those of ordinary skill in the related arts when provided the present disclosure.

In another variant, the transition to low power state is based at least in part on power consumption and/or remaining battery power. For example, in one such implementation when the client device's remaining power reserves drop below a first threshold (e.g., 20%) then the device automatically shortens an inactivity timer for low power mode. In some variants, if the device falls below a subsequent threshold (e.g., 3%), then the device automatically transitions to low power mode.

During the low power state, the exemplary embodiment of the firmware transmits keep-alive messaging (step 206). In some embodiments, the firmware additionally stores any received network responses in a memory for later use. In some embodiments, the firmware may discard response which appear redundant, incorrect, or otherwise unusable, etc. In other embodiments, the firmware may always discard responses (higher layer software may be required to resolve network layer changes).

During the low power operation, the device may additionally monitor for wake up events. Wake up events can be based on e.g., user input, application input, network input, device motion or configuration changes, etc. For example, the user can trigger the wake up procedure with a button press, switch, opening of a clamshell form factor, mouse selection, touch screen or speech input, network activity, user activity, motion of the device, environmental conditions (e.g., temperature exceeding a certain value), etc.

Once a wake event has occurred, the client device wakes (step 208 of the method 200). During wakeup procedures, the processor resumes normal operation. This may include for example resumption of high level software processes, and/or reinitiating network connection. In some embodiments, the firmware provides the results of network responses to assist in the wake up process; for example, the communication stack software may update its network address tables with ARP information that was collected by the firmware during low power operation.

Those of ordinary skill in the related arts will recognize that the various embodiments described herein are suited for IP network technologies; however those of ordinary skill in the related arts will recognize that the various principles described herein are widely applicable to other network technologies, given the contents of the present disclosure.

### Example Operation

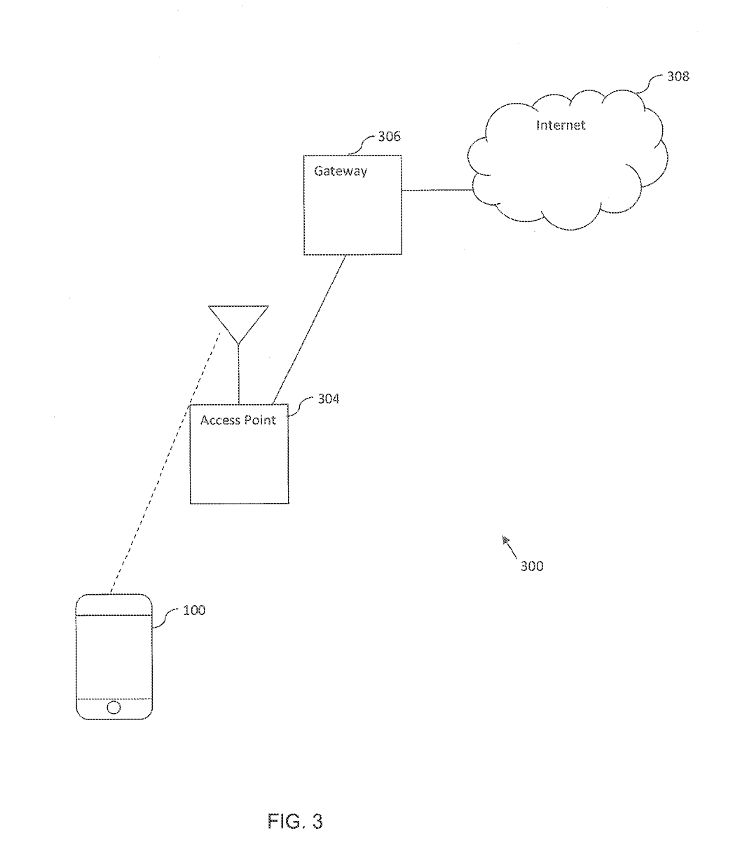

Consider the exemplary Wi-Fi network 300 of FIG. 3. As shown, the network includes a number of Wi-Fi stations (STA) 100, one or more access points (APs) 304, and a gateway 306 which is coupled to the Internet 308. It is appreciated that the foregoing is purely illustrative; various network implementations may further consolidate and/or subdivide the various entities. For example, in some embodiments, an AP includes the logical functionality of a gateway.

As previously stated, during operation, the STA 100 synchronizes and associates with the AP 304. Subsequently thereafter, the STA 100 connects to the gateway 306, which assigns the STA 100 an internet protocol (IP) address. Thereafter, the STA can freely send and receive data via the gateway 306 to other devices or servers on the WLAN and/or the Internet 308. An active connection (also referred to as a session) between the AP and the STA may be characterized by one or more session parameters. The parameters may include the assigned IP address, session association ID, session encryption key, time of establishing the connection, connection lifespan (e.g., time elapsed since connection establishment), session statistics (e.g., number of received packets and/or and number of transmitted packets) and/or other parameters. In this scenario, network entities perform regular maintenance to ensure that network operates smoothly. For example, the gateway 306 may regularly check the population of associated devices for inactive and/or underutilized resources which can be reallocated. In one such variant, the gateway 306 identifies inactive devices according to a minimum amount of activity occurring within a time interval; devices which fall below this threshold may be considered inactive and ejected from (or kicked off) the network thereby terminating the respective active session associated with the device.

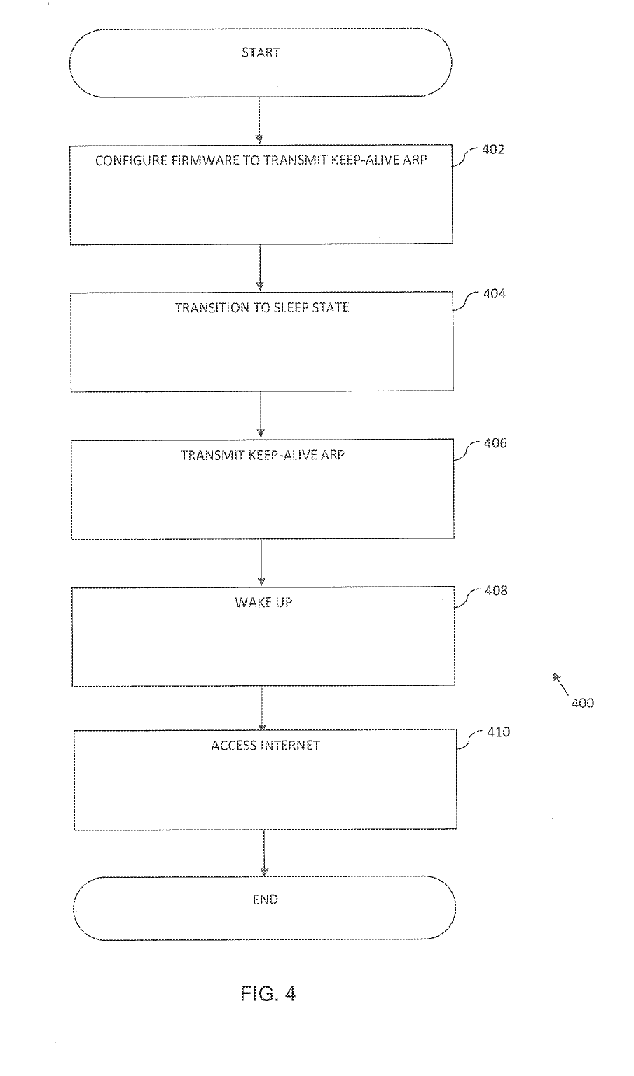

Referring now to FIG. 4, a logical flow diagram of one exemplary embodiment of a keep-alive messaging process for the Wi-Fi STA client device 100 is illustrated.

At step 402, the Wi-Fi STA client device configures its firmware to transmit a unicast address resolution protocol (ARP) message addressed to the gateway once every 90 seconds. In this scenario, higher layer software (such as the operating system (OS)) preloads the firmware with the appropriate network information for the network gateway (e.g., an IP address of 192.168.1.1, and a MAC address of c4:2c:03:1e:c3:e2).

At step 404 of the method 400, the client device transitions to a low power state. For example, in this particular scenario, the user closes the clamshell lid of their client device. Responsively, the device powers down its screen, processor, etc. and enters a “sleep” state. During the sleep state, the firmware remains operational, and performs various maintenance tasks.

At step 406 of the method 400, the firmware periodically transmits keep-alive messaging during the sleep state, per the periodic interval. In this case, the keep-alive ARP packets are addressed to the network gateway IP address (using the previously stored IP address and MAC address). Individual ARP packets may include: hardware type (HTYPE) (e.g., Ethernet has an HTYPE value of 1), protocol type (PTYPE) (e.g., IPv4 is 0x800), operation (OPER) (e.g., ARP requests have a value of 1), sender hardware address (SHA), sender protocol address (SPA), target hardware address (THA), and target protocol address (TPA). In this example, the unicast ARP THA is set to e4:2c:03:1e:c3:e2, and the TPA is set to 192.168.1.1.

A detailed discussion of ARP packets is now provided. The ARP Request frame body may include the following four (4) fields: the Sender MAC Address (or SHA), the Sender IP Address (or SPA), the Target MAC Address (or THA), and the Target IP Address (or TPA). These components are coupled with the MAC destination address (DA) to make the “standard” or “common” ARP discovery frame. For example, a common ARP discovery frame might look like:

MAC DA: Broadcast (ff:ff:ff:ff:ff:ff)

Sender MAC Address: (70:cd:60:a9:e2:c9)
Sender IP Address: (192.168.1.111)
Target MAC Address: (00:00:00:00:00:00)
Target IP Address: (192.168.1.1)

As indicated, the standard ARP discovery frame is destined to be broadcast, and the Target MAC Address is a null value of all zeros. Colloquially, this is akin to the client device blindly asking everyone, “who has the IP address 192.168.1.1?” Another type of ARP packet is the “gratuitous ARP”, which is structured as such:

MAC DA: Broadcast (ff:ff:ff:ff:ff:ff)

Sender MAC Address: (70:cd:60:a9:e2:c9)
Sender IP Address: (192.168.1.111)
Target MAC Address: (00:00:00:00:00:00)
Target IP Address: (192.168.1.111)

Colloquially, a gratuitous ARP is akin to the client device asking “I'd like to make sure everyone else is not using 192.168.1.111, please respond if you are.” Gratuitous ARP requests may help in detecting IP conflicts. When a machine receives an ARP request containing a source IP that matches its own, then it may determine that there is an IP conflict.

In contrast to the aforementioned ARP and gratuitous ARP, a unicast ARP is directed to the intended recipient. The unicast ARP is structured as:

MAC DA: c4:2c:03:1e:c3:e2

Sender MAC Address: (70:cd:60:a9:e2:c9)
Sender IP Address: (192.168.1.111)
Target MAC Address: (c4:2c:03:1e:c3:e2)
Target IP Address: (192.168.1.1)

Unlike either the ARP or the gratuitous ARP, the unicast ARP has the MAC DA set to a unicast destination address. In this scenario, the unicast ARP will be sent directly to the Gateway MAC Address (i.e., it is not broadcast to other devices). Additionally, the Target MAC Address field is filled in, and matches the MAC DA.

Referring back to FIG. 4, when the network gateway information is accurate, then the network gateway will respond with an ARP response that contains the gateway's MAC address (c4:2c:03:1e:c3:e2) and IP address (192.168.1.1). Otherwise, no response will be received, and the firmware will indicate that the network gateway information has changed (or is otherwise stale). In some variants, unsuccessful unicast ARPs may be followed by broadcast or multicast ARPs (for a broadcast ARP, the THA is set to if:if:if:if:if:ff). Broadcast ARPs will result in a response from the network entity with the TPA of the ARP request (presumably the network gateway).

At a later point (step 408), the user reopens the device clamshell lid, and responsively the firmware wakes the client device by resuming high level software. Additionally, the firmware updates the network communication software with the most recent ARP information.

At step 410, the client device is able to access the network almost immediately, as the client device has managed to remain active on the wireless network.

### Exemplary Access Point (AP) Apparatus

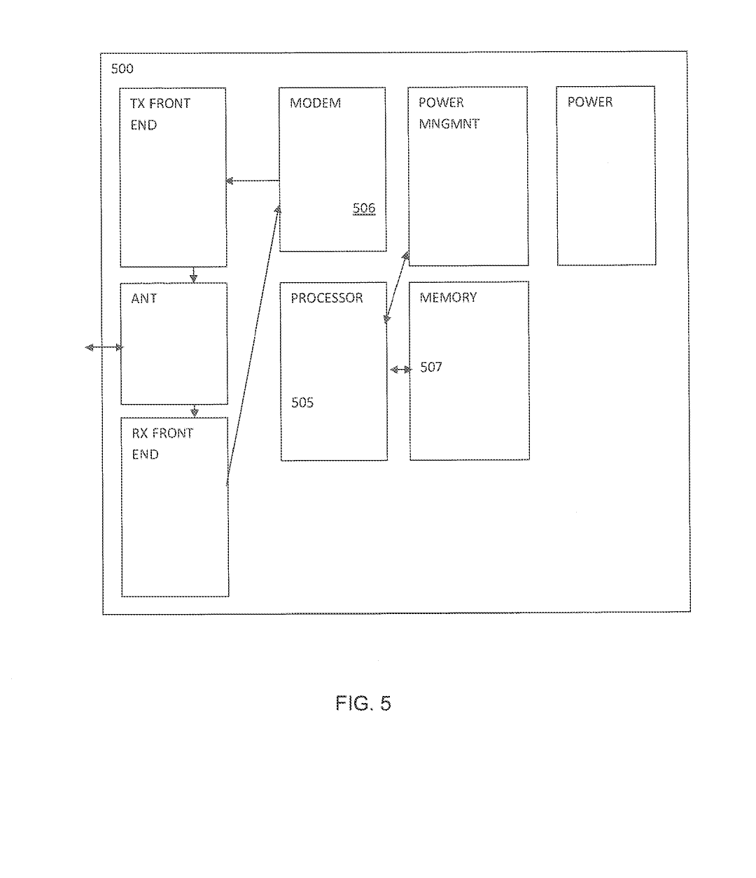

Referring now to FIG. 5, exemplary server (e.g., Access Point (AP), base station (BS), etc.) apparatus 500 useful in implementing the methods of the present invention is illustrated. As used herein, the terms “server” and “AP” include, but are not limited to access points, base stations (e.g., NodeB, eNodeB, etc.), relay stations, etc. While the following described embodiments are configured to execute software, firmware and/or hardware embodiments are also envisioned; this apparatus is described subsequently herein with respect to FIG. 5.

The AP apparatus 500 of FIG. 5 includes a wireless modem or transceiver (with one or more filters), a processing subsystem 405 such as a digital signal processor, microprocessor, field-programmable gate array, application-specific integrated circuit, and/or a plurality of processing components mounted on one or more substrates 508. The processing subsystem may also include an internal cache memory. The processing subsystem 505 is connected to a memory subsystem 507 including memory which may for example, include SRAM, flash and SDRAM components. The memory subsystem may implement one or a more of DMA type hardware, so as to facilitate data accesses as is well known in the art. In the illustrated embodiment, the processing subsystem additionally includes subsystems or modules for implementing the various schemes for network management as described previously herein. These subsystems may be implemented in software or hardware which is coupled to the processing subsystem. In another variant, the subsystems may be directly coupled to the digital baseband.

The processing subsystem 505 is configured to, in conjunction with the wireless modem, provide a wireless network for one or more client devices. In one embodiment, the wireless modem is configured to transmit and receive one or more wireless data transmissions from one or more client devices. In one exemplary implementation, the wireless modem includes a Wi-Fi™ modem and radio. In some variants, the radio may include: one or more antennas (the latter to support, e.g., MIMO functionality), analog to digital converters (ADC), digital to analog converters (DAC), mixers, filters, duplexers, diplexers, switches, and/or other components. The modem may support one or more other wireless technologies e.g., cellular technologies (e.g., Global System for Mobile Communications (GSM), General Radio Packet Service (GPRS), Enhanced Data Rates for GSM Evolution (EDGE), Long Term Evolution (LTE), LTE-Advanced (LTE-A), Interim Standard 95 (IS-95), Interim Standard 2000 (IS-2000, also referred to as CDMA2000), CDMA 1XEV-DO, Time Division Single Carrier CDMA (TD-SCDMA), Long Term Evolution (LTE), Time Division LTE (TD LTE), etc.), personal area network technologies (e.g., Bluetooth, Zigbee, wireless USB, etc.).

Additionally, the processing subsystem 505 includes logic configured to enable a client device to operate in a low power mode (such as sleep, or hibernation, etc.) without unnecessarily kicking the client device from the wireless network. In one embodiment, the logic is configured to during a low power state of a client device: responsive to receiving one or more messages from the client device, maintain a session of the client device within the network.

It will be recognized that while certain features are described in terms of a specific sequence of steps of a method, these descriptions are only illustrative of the broader methods disclosed herein, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure and claims herein.

While the above detailed description has shown, described, and pointed out novel features as applied to various embodiments, it will be understood that various omissions, substitutions, and changes in the form and details of the device or process illustrated may be made by those skilled in the art. The foregoing description is of the best mode presently contemplated. This description is in no way meant to be limiting, but rather should be taken as illustrative of the general principles described herein.

What is claimed is:

1. A method for operating a user equipment (UE) device of a wireless network, the method comprising:
configuring one or more messaging parameters, where at least one of the messaging parameters comprises an address of the network;
responsive to a sleep event, transitioning to a low power state; and
during at least the low power state:
transmitting at least one message comprising the at least one messaging parameter, the at least one message causing a transmission of a corresponding one or more responses by a network entity;
storing the one or more responses; and
responsive to a wake event, resuming a normal state.

2. The method of claim 1, where the network entity comprises a gateway of the network, the address corresponds to the gateway of the network, and the at least one message comprises a unicast address resolution protocol (ARP) message.

3. The method of claim 1, where the at least one message comprises a broadcast address resolution protocol (ARP) message, and the address corresponds to another UE device within the network.

4. The method of claim 1, where the at least one message comprises a domain name system query, and the address corresponds to a domain name server within the network.

5. The method of claim 1, where the at least one message comprises a keep-alive message, and the address corresponds to the user equipment device transmitting the at least one message.

6. The method of claim 1, further comprising detecting one or more of a lack of activity, or a lack of user input.

7. The method of claim 6, where when one or more of the lack of activity or the lack of user input is detected, triggering the sleep event.

8. The method of claim 6, where the user input comprises one or more of a button press, an audible input, a device motion, or a touch screen input.

9. The method of claim 1, where the wake event is triggered based on one or more of user input, application activity, or network activity.

10. The method of claim 1, where the wake event is based on a timer.

11. The method of claim 1, where the low power state is characterized by a lower power consumption compared to a normal mode consumption.

12. A portable radio communications apparatus, comprising:
a processor;
a power source configured to power the processor during a normal mode of operation and not power at least a portion of the processor during a low power mode of operation;
a wireless interface; and
logic configured to, when the processor is unpowered:
transmit one or more keep-alive messages to at least one wireless local area network (WLAN) entity;
where the one or more keep-alive messages are configured to cause the at least one WLAN entity to respond; and
receive one or more responses to the keep-alive message.

13. The portable radio communications apparatus of claim 12, where the at least one WLAN entity comprises a gateway of the network, and the one or more keep-alive messages comprise a unicast address resolution protocol (ARP) message.

14. The portable radio communications apparatus of claim 12, where the one or more keep-alive messages comprise a broadcast address resolution protocol (ARP) message, and the at least one WLAN entity is another UE device.

15. The portable radio communications apparatus of claim 12, where the one or more keep-alive messages comprise a domain name system query, and the at least one WLAN entity corresponds to a domain name server.

16. The portable radio communications apparatus of claim 12, further comprising logic configured to store the received one or more responses in non-transitory computer readable medium.

17. The portable radio communications apparatus of claim 16, where the processor is configured to retrieve the stored one or more responses upon a wakeup condition.

18. An access point apparatus, comprising:
a processor;
a wireless transceiver; and
logic configured to enable a client device to operate in a low power mode without unnecessarily forcing the client device from the wireless network, the logic configured to, during a low power state of a client device and
responsive to reception of one or more messages from the client device, maintain a session of the client device within the network.

19. The access point apparatus of claim 18, where the one or more messages comprise one or more messages comprise a unicast address resolution protocol (ARP) message.

20. The access point apparatus of claim 18, where the one or more messages comprise a broadcast address resolution protocol (ARP) message.
